(19) United States
(12) Patent Application Publication
(10) Pub. No.: US 2023/0361867 A1
(43) Pub. Date: Nov. 9, 2023

(54) MULTIPLEX TRANSMISSION SYSTEM, RESOURCE CONTROL METHOD FOR MULTIPLEX TRANSMISSION SYSTEM

(71) Applicant: NIPPON TELEGRAPH AND TELEPHONE CORPORATION, Tokyo (JP)

(72) Inventors: Hiroko NOMURA, Musashino-shi, Tokyo (JP); Keita TAKAHASHI, Musashino-shi, Tokyo (JP)

(73) Assignee: NIPPON TELEGRAPH AND TELEPHONE CORPORATION, Tokyo (JP)

(21) Appl. No.: 18/028,631

(22) PCT Filed: Oct. 7, 2020
(86) PCT No.: PCT/JP2020/038013

§ 371 Date: Mar. 27, 2023

(51) Int. Cl. H04B 10/03; H04L 1/1829

(52) U.S. Cl. CPC H04B 10/03; H04L 1/1854

(57) ABSTRACT

Provided is a multiplex transmission system capable of achieving a redundant configuration for coping with a failure while reducing useless resources. A multiplex transmission system includes a first multiplex transmission apparatus 100, a second multiplex transmission apparatus 200, a resource pool 130 having resources capable of selectively constructing one or more functions among a plurality of functions, and a management control unit 140 for controlling the resource pool 130. The first multiplex transmission apparatus 100 includes a plurality of client ports. During normal time, a function associated with each of the plurality of client ports is constructed in the resource pool 130. When a failure occurs, the management control unit 140 controls the resource pool 130 so as to release a resource in which is constructed a function associated with a port with a low priority among the plurality of client ports and to construct, in the resource, a function necessary for restoring signal transmission associated with a port with a high priority among the plurality of client ports.

### TECHNICAL FIELD

The present disclosure relates to a multiplex transmission system and a resource control method for the multiplex transmission system.

### BACKGROUND ART

A multiplex transmission system for multiplexing and transmitting a plurality of signals between two points is disclosed in NPL 1. Specifically, NPL 1 discloses multiplexing a plurality of signals using wavelength division multiplexing (WDM). At each of the two points to be transmitted, a multiplex transmission apparatus for performing wavelength demultiplexing is installed.

In addition, a redundancy technique of an access network is described in NPL 2. In order to cope with various failures such as a disconnection of an optical fiber cable connecting a multiplex transmission apparatus or a breakdown of a transmission/reception unit (TRx) in the multiplex transmission apparatus, a redundancy technique as described in NPL 2 is required.

### CITATION LIST

### Non Patent Literature

[NPL 1] Optical Interface Standardization Trend of Access Networks, NTT Technical Journal, July 2007, pp. 46-49
[NPL 2] Next-Generation Ethernet Technology for The NGN Era, NTT Technical Journal, May 2009, pp. 22-23

### SUMMARY OF INVENTION

### Technical Problem

In a conventional redundancy technique such as that described in NPL 2, it is necessary to prepare resources of a standby system in advance from a stage of introduction of a multiplex transmission system in preparation for a failure. The resources of the standby system required in the conventional redundancy technique end up being wasted during normal time where no failure occurs.

The present disclosure has been devised to solve the foregoing problem. An object of the present disclosure is to provide a multiplex transmission system and a multiplex transmission system resource control method capable of achieving a redundant configuration for coping with a failure while reducing useless resources.

### Solution to Problem

A multiplex transmission system according to the present disclosure is a multiplex transmission system which multiplexes and transmits a plurality of signals between a first multiplex transmission apparatus and a second multiplex transmission apparatus, the multiplex transmission system including: a resource pool which is provided in the first multiplex transmission apparatus and which has a resource capable of selectively constructing one or more functions among a plurality of functions; and a control unit which controls the resource pool. The first multiplex transmission apparatus includes a plurality of client ports to which a client apparatus can be connected. During normal time, a function associated with each of the plurality of client ports is constructed in the resource pool. When a failure occurs, the control unit controls the resource pool so as to release a resource in which is constructed a function associated with a port having a low priority among the plurality of client ports and to construct, in the resource, a function necessary for restoring signal transmission associated with a port having a high priority among the plurality of client ports.

A resource control method for a multiplex transmission system according to the present disclosure is a method for controlling, in a multiplex transmission system which multiplexes and transmits a plurality of signals between a first multiplex transmission apparatus and a second multiplex transmission apparatus, a resource pool which is provided in the first multiplex transmission apparatus and which has a resource capable of selectively constructing one or more functions among a plurality of functions. The resource control method includes the steps of: constructing a function associated with each of a plurality of client ports provided in the first multiplex transmission apparatus in the resource pool during normal time; releasing a resource in which is constructed a function associated with a port having a low priority among the plurality of client ports during an occurrence of a failure; and constructing a function necessary for restoring signal transmission associated with a port having a high priority among the plurality of client ports in the resource released by the releasing step.

### Advantageous Effects of Invention

With the multiplex transmission system and the resource control method of the multiplex transmission system according to the present disclosure, a redundant configuration for coping with a failure can be realized while reducing useless resources.

### BRIEF DESCRIPTION OF DRAWINGS

FIG. 1 is a diagram schematically showing an example of an overall configuration of a multiplex transmission system according to a first embodiment.

FIG. 2 is a block diagram showing a configuration of a multiplex transmission apparatus included in the multiplex transmission system according to the first embodiment.

FIG. 3 is a flow chart showing a flow of a resource control method of the multiplex transmission system according to the first embodiment.

FIG. 4 is a block diagram describing an operation example during normal time of the multiplex transmission system according to the first embodiment.

FIG. 5 is a block diagram describing an operation example during an occurrence of a failure of the multiplex transmission system according to the first embodiment.

### DESCRIPTION OF EMBODIMENTS

A mode for carrying out a multiplex transmission system and a resource control method for the multiplex transmission system according to the present disclosure will be described with reference to the drawings. In each drawing, same reference signs are assigned to identical or corresponding parts and repetition of description will be simplified or omitted as deemed appropriate. It should be noted that the present disclosure is not limited to the following embodiment and any constituent element disclosed in the embodiment can be modified or omitted without departing from the spirit and the scope of the present disclosure.

### First Embodiment

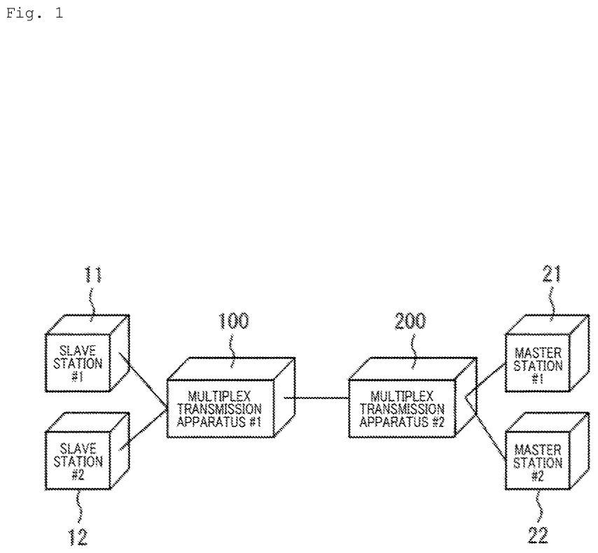

FIG. 1 is a diagram schematically showing an example of an overall configuration of a multiplex transmission system according to a first embodiment. As shown in FIG. 1, the multiplex transmission system according to the present embodiment includes a first multiplex transmission apparatus 100 and a second multiplex transmission apparatus 200. The multiplex transmission system according to the present embodiment is a system for multiplexing and transmitting a plurality of signals between the first multiplex transmission apparatus 100 and the second multiplex transmission apparatus 200. The multiplex transmission system according to the present disclosure is applicable to systems using various known signal multiplexing methods. As a specific signal multiplexing method, wavelength division multiplexing (WDM), frequency division multiplexing (FDM), time division multiplexing (TDM), code division multiplexing (CDM), and the like can be cited. Here, an example in which wavelength division multiplexing (WDM) is used will be described.

The first multiplex transmission apparatus 100 and the second multiplex transmission apparatus 200 are communicably connected by an optical fiber cable. According to the multiplex transmission system, by multiplexing a plurality of signals to be transmitted between two points, the number of optical fiber cables required for transmitting the plurality of signals between the two points can be reduced. For example, the first multiplex transmission apparatus 100 and the second multiplex transmission apparatus 200 can be communicably connected to each other by one optical fiber cable.

One or more slave stations are communicably connected to one of the first multiplex transmission apparatus 100 and the second multiplex transmission apparatus 200. One or more master stations are communicably connected to the other of the first multiplex transmission apparatus 100 and the second multiplex transmission apparatus 200. In the illustrated configuration example, a first slave station 11 and a second slave station 12 are connected to the first multiplex transmission apparatus 100 and a first master station 21 and a second master station 22 are connected to the second multiplex transmission apparatus 200.

In the present embodiment, it is intended that the multiplex transmission system is applied to a mobile front hole. In this case, the first master station 21 and the second master station 22 correspond to CUs (Central Units) and/or DUs (Distributed Units) of a base station. In addition, in this case, the first slave station 11 and the second slave station 12 correspond to RUs (Radio Units). The first slave station 11 and the first master station 21 are base stations of a first mobile carrier. The second slave station 12 and the second master station 22 are base stations of a second mobile carrier. The first mobile carrier and the second mobile carrier are different mobile carriers (mobile communication providers). An antenna is connected to each slave station. Each antenna outputs a radio wave to an individual area to form a reception area. Each master station may be formed as an individual apparatus for each mobile carrier or formed as an integrated apparatus. Similarly, each slave station may be formed as a separate apparatus for each mobile carrier or formed as an integrated apparatus.

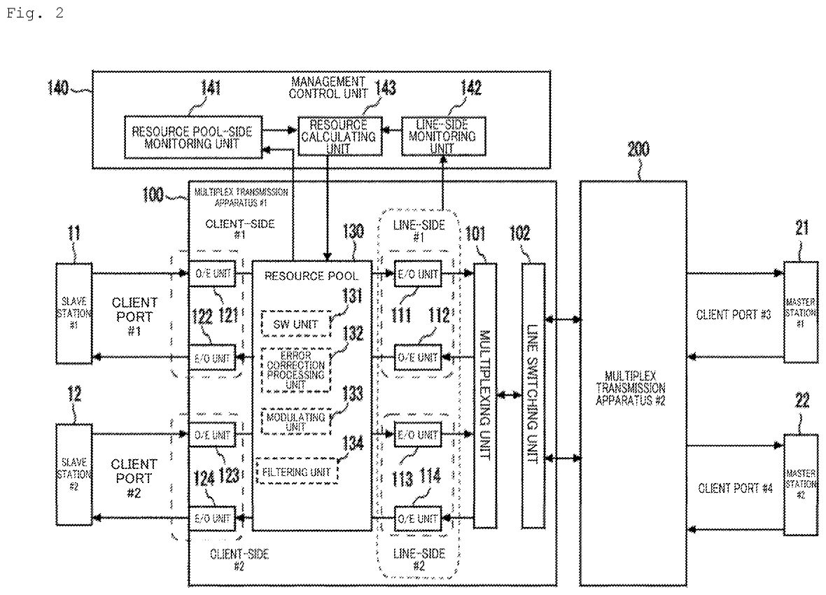

FIG. 2 is a block diagram showing a configuration of a multiplex transmission apparatus included in the multiplex transmission system according to the first embodiment. Here, master stations and slave stations connected to the first multiplex transmission apparatus 100 and the second multiplex transmission apparatus 200 will be collectively called client apparatuses. Each of the first multiplex transmission apparatus 100 and the second multiplex transmission apparatus 200 is provided with a plurality of client ports to which a client apparatus can be connected. In the illustrated configuration example, two client ports are provided in each of the first multiplex transmission apparatus 100 and the second multiplex transmission apparatus 200. In order to facilitate discrimination, the two client ports provided in the first multiplex transmission apparatus 100 will be referred to as a first client port and a second client port. In addition, the two client ports provided in the second multiplex transmission apparatus 200 will be referred to as a third client port and a fourth client port. In each diagram, “first” is indicated by “#1”, “second” is indicated by “#2”, “third” is indicated by “#3”, and “fourth” is indicated by “#4”.

The first client port of the first multiplex transmission apparatus 100 is provided with a first client-side O/E unit 121 and a first client-side E/O unit 122. The second client port of the first multiplex transmission apparatus 100 is provided with a second client-side O/E unit 123 and a second client-side E/O unit 124. The first multiplex transmission apparatus 100 further includes a first line-side E/O unit 111, a first line-side O/E unit 112, a second line-side E/O unit 113 and a second line-side O/E unit 114, and a first multiplexing unit 101.

An optical signal input to the first client port of the first multiplex transmission apparatus 100 is converted into an electric signal by the first client-side O/E unit 121 and output to the first line-side E/O unit 111. The first line-side E/O unit 111 converts the input electric signal into an optical signal and outputs the optical signal to the first multiplexing unit 101. In addition, an optical signal input to the second client port of the first multiplex transmission apparatus 100 is converted into an electric signal by the second client-side O/E unit 123 and output to the second line-side E/O unit 113. The second line-side E/O unit 113 converts the input electric signal into an optical signal and outputs the optical signal to the first multiplexing unit 101.

The first multiplexing unit 101 multiplexes the optical signals input from the first line-side E/O unit 111 and the second line-side E/O unit 113. The optical signal multiplexed by the first multiplexing unit 101 is transmitted from the first multiplex transmission apparatus 100 to the second multiplex transmission apparatus 200.

In addition, a multiplexed optical signal transmitted from the second multiplex transmission apparatus 200 to the first multiplex transmission apparatus 100 is input to the first multiplexing unit 101. The first multiplexing unit 101 separates the multiplexed signal input from the second multiplex transmission apparatus 200 and outputs the separated signal to the first line-side O/E unit 112 and the second line-side O/E unit 114, respectively.

The first line-side O/E unit 112 converts the optical signal input from the first multiplexing unit 101 into an electric signal and outputs the electric signal to the first client-side E/O unit 122. The first client-side E/O unit 122 converts the input electric signal into an optical signal and outputs the optical signal to the first client port of the first multiplex transmission apparatus 100. The second line-side O/E unit 114 converts the optical signal input from the first multiplexing unit 101 into an electric signal and outputs the electric signal to the second client-side E/O unit 124. The second client-side E/O unit 124 converts the input electric signal into an optical signal and outputs the optical signal to the second client port of the first multiplex transmission apparatus 100.

In this way, the first line-side E/O unit 111, the first line-side O/E unit 112, the first client-side O/E unit 121 and the first client-side E/O unit 122 correspond to the first client port of the first multiplex transmission apparatus 100. In addition, the second line-side E/O unit 113, the second line-side O/E unit 114, the second client-side O/E unit 123 and the second client-side E/O unit 124 correspond to the second client port of the first multiplex transmission apparatus 100. The second multiplex transmission apparatus 200 is configured in the same manner as the first multiplex transmission apparatus 100. Illustration of an internal configuration of the second multiplex transmission apparatus 200 will be omitted. As described above, the second multiplex transmission apparatus 200 is provided with the third client port and the fourth client port. The second multiplex transmission apparatus 200 includes a client-side O/E unit and a client-side E/O unit that correspond to each client port. The second multiplex transmission apparatus 200 includes a line-side O/E unit and a line-side E/O unit that correspond to each client port. In addition, the second multiplex transmission apparatus 200 includes a second multiplexing unit which functions similarly to the first multiplexing unit 101.

The line-side O/E units and the line-side E/O units included in each multiplex transmission apparatus are made of optical modules that emit light at a fixed wavelength. The line-side O/E units and the line-side E/O units included in the first multiplex transmission apparatus 100 can communicate only with an optical module which emits light at the same wavelength as themselves among the line-side O/E units and the line-side E/O units included in the second multiplex transmission apparatus 200.

Each slave station and the first multiplex transmission apparatus 100 may be connected to each other via a coupler (not illustrated) in order to construct a redundant configuration of a transmission line. Similarly, each master station and the second multiplex transmission apparatus 200 may be connected to each other via a coupler for constructing a redundant configuration of a transmission line. In place of the coupler, a switch capable of switching between transmission lines provided inside each multiplex transmission apparatus may be used to construct a redundant configuration of the transmission line between the base station and each multiplex transmission apparatus.

In the illustrated configuration example, the first multiplex transmission apparatus 100 includes a first line switching unit 102 for constructing a redundant configuration of a transmission line between multiplex transmission apparatuses. Although not illustrated, the second multiplex transmission apparatus 200 includes a second line switching unit that functions similarly to the first line switching unit 102. The line switching units are for constructing a redundant configuration of a transmission line between the multiplex transmission apparatuses. The line switching units are connected to each other by a plurality of paths (optical fiber cables). In the illustrated configuration example, the line switching units are connected to each other by two paths. A signal from the multiplexing units is input to the line switching units. The line switching units select an arbitrary path among the plurality of paths connecting the line switching units, and outputs a signal from the multiplexing unit to the selected line. The line switching units may be provided outside the multiplex transmission apparatuses. As described above, in the present embodiment, the first multiplex transmission apparatus 100 and the second multiplex transmission apparatus 200 are connected to each other by a plurality of switchable transmission paths.

In addition, as shown in FIG. 2, in the present embodiment, the first multiplex transmission apparatus 100 includes a resource pool 130. The resource pool 130 has a resource capable of selectively constructing one or more functions of a plurality of functions. The resource pool 130 is constituted of, for example, a rewritable FPGA. Various electrical functions can be flexibly added to and deleted from the resource pool 130. The resource pool 130 can be partially or entirely rewritten as necessary to construct a necessary function. During normal time in which no failure occurs, the resource pool 130 constructs a function necessary or effective during normal time. In addition, when a failure occurs, the resource pool 130 constructs a function for realizing a redundant configuration for coping with the failure.

In the present disclosure, a redundant configuration is constructed using the resource pool 130 that functions both during normal time and during an occurrence of a failure. Thus, resources can be utilized more effectively than before. According to the present disclosure, it is possible to achieve a redundant configuration for coping with a failure while reducing useless resources.

The resource pool 130 may also be provided in the second multiplex transmission apparatus 200. In the present disclosure, the resource pool 130 need only be provided in at least one of the first multiplex transmission apparatus 100 and the second multiplex transmission apparatus 200.

Functional units that can be constructed in resources of the resource pool 130 include, for example, an SW unit 131, an error correction processing unit 132, a modulating unit 133, and a filtering unit 134. The SW unit 131 has a switching function. For example, the SW unit 131 constructs a redundant path when a failure occurs in a transmission and reception unit such as each O/E unit and each E/O unit in the first multiplex transmission apparatus 100.

The error correction processing unit 132 has a function of correcting a bit error rate due to signal deterioration occurring on a transmission path. The error correction processing unit 132 detects and corrects an error on a reception-side on the basis of an error correction code added to data on a transmission-side. An arbitrary code such as a Reed-Solomon code or an LDPC code is allocated to the error correction code. The error correction processing unit 132 is constructed in a resource of the resource pool 130 when, for example, a path of a switching destination becomes long in the case of a line breakdown.

The modulating unit 133 has a function of converting a signal from a client port into a multi-valued signal. The modulating unit 133 generates, for example, a PAM4 signal. The modulating unit 133 can increase a bit rate while maintaining a baud rate. The modulating unit 133 can reduce the cost of an O/E unit and an E/O unit, for example.

The filtering unit 134 is used to lower a transmission rate and has a function of filtering and discarding a part of a main signal.

In addition, the multiplex transmission system according to the present embodiment includes a management control unit 140 as a control unit for controlling the resource pool 130. The management control unit 140 includes, for example, a resource pool-side monitoring unit 141, a line-side monitoring unit 142, and a resource calculating unit 143. Although the management control unit 140 is provided outside the first multiplex transmission apparatus 100 in the illustrated configuration example, at least a part of the functions of the management control unit 140 may be provided inside the first multiplex transmission apparatus 100. In addition, at least a part of the functions of the management control unit 140 may be provided inside the second multiplex transmission apparatus 200.

The resource pool-side monitoring unit 141 monitors a current state of the resource pool 130. Monitoring information by the resource pool-side monitoring unit 141 is sent to the resource calculating unit 143. The line-side monitoring unit 142 monitors states of the first line-side E/O unit 111, the first line-side O/E unit 112, the second line-side E/O unit 113, and the second line-side O/E unit 114. The monitoring information by the line-side monitoring unit 142 is sent to the resource calculating unit 143. For example, when any one of the first line-side E/O unit 111, the first line-side O/E unit 112, the second line-side E/O unit 113, and the second line-side O/E unit 114 breaks down, the line-side monitoring unit 142 notifies the resource calculating unit 143 of the breakdown. The resource calculating unit 143 performs calculation processing for constructing each functional unit in a resource in the resource pool 130. The resource calculating unit 143 performs calculation processing on the basis of the monitoring information transmitted from the resource pool-side monitoring unit 141 and the line-side monitoring unit 142. In addition, the resource calculating unit 143 instructs the resource pool 130 to construct a necessary functional unit on the basis of the calculation processing result.

The management control unit 140 may be constituted of a computer including a processor and a memory as hardware. The processor is also referred to as a CPU (Central Processing Unit), a central processing device, processing equipment, an arithmetic unit, a microprocessor, a microcomputer, or a DSP. As the memory, for example, non-volatile or volatile semiconductor memories such as a RAM, a ROM, a flash memory, an EPROM, or an EEPROM, a magnetic disk, an optical disk, a flexible disk, an optical disk, a compact disc, a mini disk, a DVD, and the like are applicable.

A program as software is stored in the memory of the management control unit 140. The management control unit 140 performs preset processing by causing a processor to execute a program stored in the memory and implements each function as a result of cooperation between hardware and software.

Next, a flow of operations of the multiplex transmission system configured as described above will be described. As a premise, it is assumed that functions associated with each of the plurality of client ports are constructed in the resource pool 130 during normal time where no failure occurs. During normal time, the management control unit 140 controls the resource pool 130 so that functions associated with each of the plurality of client ports are constructed. This control step during normal time is also referred to as a normal-time function construction step in the present disclosure.

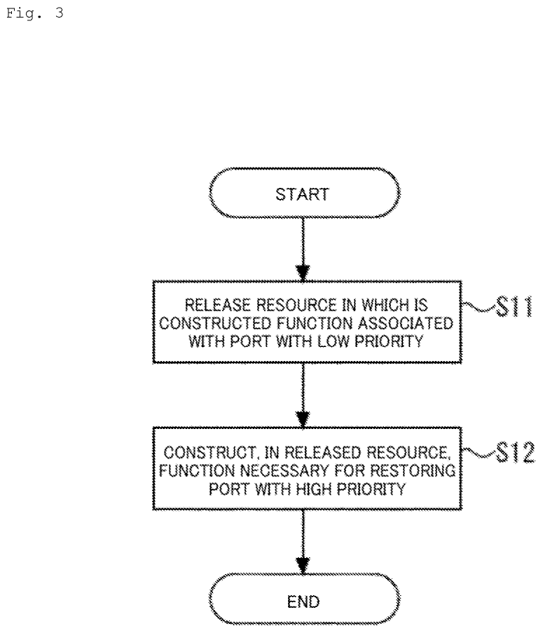

FIG. 3 is a flow chart showing a flow of a resource control method of the multiplex transmission system according to the first embodiment. FIG. 3 describes operations in the event of an occurrence of a failure. When a failure occurs, first, in step S11, a resource in which is constructed a function associated with a port having a low priority among a plurality of client ports is released. The processing in step S11 is also referred to as a resource release step in the present disclosure.

In subsequent step S12, a function necessary for restoring signal transmission associated with a port with high priority among the plurality of client ports is constructed in the resource having been released in the resource releasing step. The processing in step S12 is also referred to as a function reconstruction step in the present disclosure. By the function reconstruction step, signal transmission associated with the port with high priority is quickly restored. The resource release step and the function reconstruction step are implemented by the management control unit 140 by controlling the resource pool 130.

According to the resource control method as shown in FIG. 3 and the multiplex transmission system configured to be capable of executing the resource control method, a redundant configuration capable of restoring communication in a port having high priority upon occurrence of a failure can be realized while reducing useless resources.

A port with a low priority is, for example, a best-effort port. A port with a high priority is, for example, a port of which traffic is guaranteed. A priority of each port is determined, for example, at the time of setting a port when the multiplex transmission system is installed. Further, for example, by placing a traffic identifier of each port and monitoring a quality (CoS value) of a packet at each port, a port through which a larger amount of high-quality packets flow may be estimated as a port with a high priority.

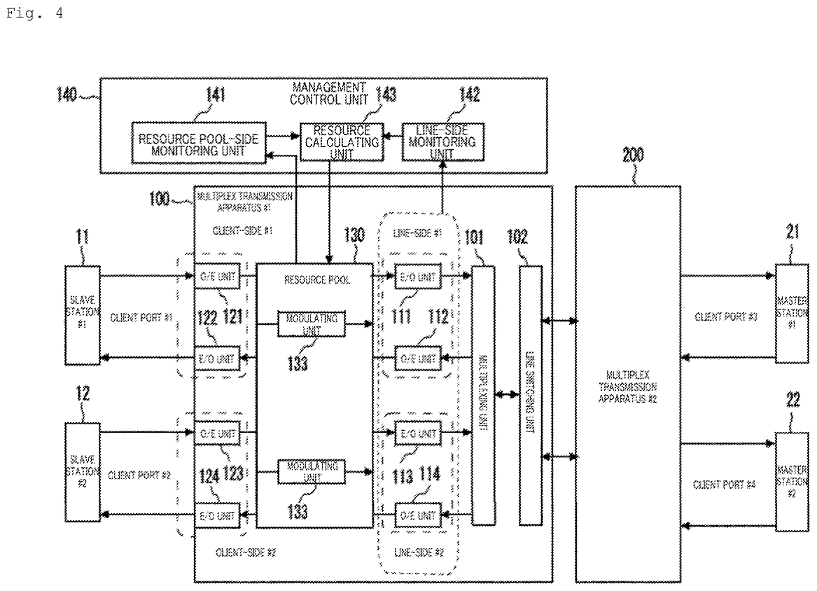

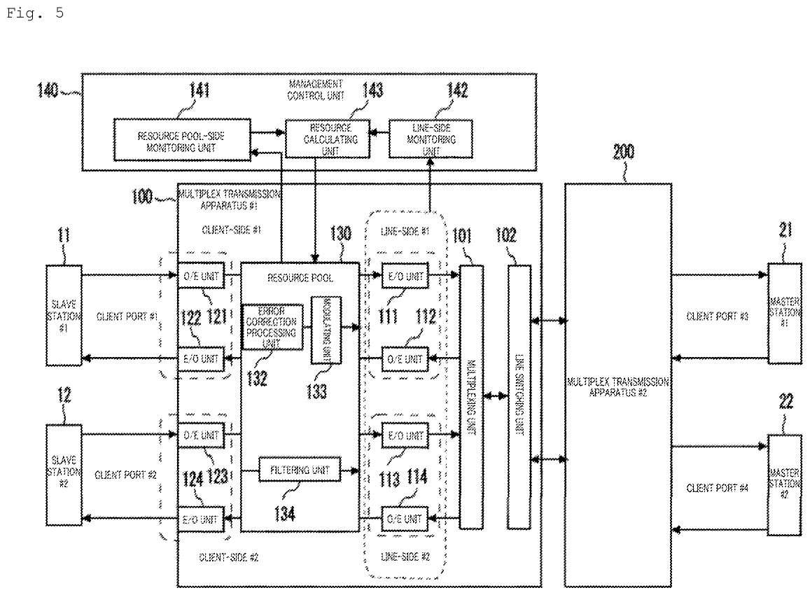

FIG. 4 is a block diagram describing an operation example during normal time of the multiplex transmission system according to the first embodiment. FIG. 5 is a block diagram describing an operation example during an occurrence of a failure of the multiplex transmission system according to the first embodiment. As shown in FIG. 4, during normal time, the modulating unit 133 for converting signals from each of a plurality of client ports into multi-valued signals is constructed in the resource pool 130 as an example.

FIG. 5 illustrates an operation of the multiplex transmission system constructed as shown in FIG. 4 when a failure occurs in a transmission path connecting the first multiplex transmission apparatus 100 and the second multiplex transmission apparatus 200 to each other. In the examples shown in FIGS. 4 and 5, the first client port is a port having a high priority and the second client port is a port having a low priority. In the examples shown in FIGS. 4 and 5, when a failure occurs, the resources in which is constructed the modulating unit 133 associated with the second client port are released. Then, the filtering unit 134 for lowering a transmission speed at the second client port is constructed by using the released resource. For example, the transmission speed at the second client port is reduced from 25 G to 10 G.

In the examples shown in FIGS. 4 and 5, the error correction processing unit 132 associated with the first client port is further constructed using resources released when a failure occurs. Thus, even when the switching destination of the transmission line becomes long at the time of the occurrence of a failure, signal transmission at a port of high priority can be performed without error.

The operations of the multiplex transmission system according to the present disclosure are not limited to the examples shown in FIGS. 4 and 5. For example, when the SW unit 131 needs to be constructed to restore a port having a high priority, the SW unit 131 is constructed in the resource pool 130. Further, a functional unit constructed in the resource pool 130 during normal time is not limited to the modulating unit 133 and may be any functional unit according to the design of the multiplex transmission system.

In addition, the multiplex transmission apparatus constituting the multiplex transmission system according to the present disclosure and the resource control method of the multiplex transmission system can also be realized through cooperation between hardware and software by having a processor execute a program stored in a memory to perform preset processing. Furthermore, a program for realizing the apparatus and the method according to the present disclosure can be recorded on an information recording medium. Alternatively, a program for realizing the apparatus and the method according to the present disclosure can also be provided via a communication network.

### Industrial Applicability

The present disclosure can be used for a multiplex transmission system in which a plurality of signals are multiplexed and transmitted between a first multiplex transmission apparatus and a second multiplex transmission apparatus and for resource control of the multiplex transmission system.

### Reference Signs List

11 First slave station
12 Second slave station
21 First master station
22 Second master station
100 First multiplex transmission apparatus
101 First multiplexing unit
102 First line switching unit
111 First line-side E/O unit
112 First line-side O/E unit
113 Second line-side E/O unit
114 Second line-side O/E unit
121 First client-side O/E unit
122 First client-side E/O unit
123 Second client-side O/E unit
124 Second client-side E/O unit
130 Resource pool
131 SW unit
132 Error correction processing unit
133 Modulating unit
134 Filtering unit
140 Management control unit
141 Resource pool-side monitoring unit
142 Line-side monitoring unit
143 Resource calculating unit
200 Second multiplex transmission apparatus

1. A multiplex transmission system which multiplexes and transmits a plurality of signals between a first multiplex transmission apparatus and a second multiplex transmission apparatus, the multiplex transmission system comprising:
a resource pool which is provided in the first multiplex transmission apparatus and which has a resource capable of selectively constructing one or more functions among a plurality of functions; and
a control unit which controls the resource pool, wherein the first multiplex transmission apparatus includes a plurality of client ports to which a client apparatus can be connected,
during normal time, a function associated with each of the plurality of client ports is constructed in the resource pool, and
when a failure occurs, the control unit controls the resource pool so as to release a resource in which is constructed a function associated with a port having a low priority among the plurality of client ports and to construct, in the resource, a function necessary for restoring signal transmission associated with a port having a high priority among the plurality of client ports.

2. The multiplex transmission system according to claim 1,
wherein a modulating unit for converting signals from each of the plurality of client ports into multi-valued signals is constructed in the resource pool during normal time, and the control unit controls the resource pool so as to release a resource in which is constructed a modulating unit associated with a port of which the priority is low and to construct, using the resource, an error correction processing unit associated with a port of which the priority is high and a filtering unit for lowering a transmission rate at the port of which the priority is low.

3. A resource control method for a multiplex transmission system of controlling, in a multiplex transmission system which multiplexes and transmits a plurality of signals between a first multiplex transmission apparatus and a second multiplex transmission apparatus, a resource pool which is provided in the first multiplex transmission apparatus and which has a resource capable of selectively constructing one or more functions among a plurality of functions, the resource control method comprising the steps of:
constructing a function associated with each of a plurality of client ports provided in the first multiplex transmission apparatus in the resource pool during normal time;
releasing a resource in which is constructed a function associated with a port having a low priority among the plurality of client ports during an occurrence of a failure; and
constructing a function necessary for restoring signal transmission associated with a port having a high priority among the plurality of client ports in the resource released by the releasing step.

4. The resource control method for a multiplex transmission system according to claim 3, wherein, in the normal time function constructing step, a modulating unit for converting signals from each of the plurality of client ports into multi-valued signals is constructed in the resource pool, and
in the function reconstruction step, an error correction processing unit associated with a port of which the priority is high and a filtering unit for reducing a transmission rate at a port of which the priority is low are constructed.
